(19) United States
(12) Patent Application Publication
(10) Pub. No.: US 2025/0129704 A1
(43) Pub. Date: Apr. 24, 2025

(54) Identification and Characterization of Geologic Features in Carbonate Reservoir

(71) Applicant: Saudi Arabian Oil Company

(72) Inventors: Weichang Li, Katy, TX (US); Chicheng Xu, Houston, TX (US); Tao Lin, Katy, TX (US)

(21) Appl. No.: 18/490,457

(22) Filed: Oct. 19, 2023

(51) Int. Cl. E21B 47/002; G06T 7/00

(52) U.S. Cl. CPC E21B 47/0025; G06T 7/0002; G06T 7/10; G01N 15/08; G01N 15/088; G06T 2207/20081

(57) ABSTRACT

Example computer-implemented methods, media, and systems for identification and characterization of geologic features in carbonate reservoir are disclosed. One example computer-implemented method includes obtaining multiple core sample images of a carbonate reservoir. The multiple core sample images are labeled using multiple feature classes, where the multiple feature classes include at least one of a vug or fracture. Multiple image patches are generated using the labeled plurality of core sample images. A machine learning model is applied to the multiple image patches to identify one or more vugs or fractures in the multiple core sample images. At least one of porosity or permeability of the carbonate reservoir is predicted using the identified one or more vugs or fractures in the multiple core sample images.

### TECHNICAL FIELD

The present disclosure relates to computer-implemented methods, media, and systems for the identification and characterization of geologic features in carbonate reservoirs.

### BACKGROUND

Carbonate reservoirs are geological formations that contain carbonate minerals, such as limestone or dolomite. Carbonate reservoir characterization can be challenging due to lithological variations and pore-space heterogeneity of the carbonate rocks as influenced by lithofacies paleogeography, depositional, and diagenetic processes. The diverse variety of pore types, structures, geometries, and connectivity contribute to large variations in the petrophysical properties and flow mechanics of carbonate reservoirs.

### SUMMARY

The present disclosure involves computer-implemented methods, media, and systems for identification and characterization of geologic features in carbonate reservoirs. One example computer-implemented method includes obtaining multiple core sample images of a carbonate reservoir. The multiple core sample images are labeled using multiple feature classes, where the multiple feature classes include at least one of a vug or fracture. Multiple image patches are generated using the labeled plurality of core sample images. A machine learning model is applied to the multiple image patches to identify one or more vugs or fractures in the multiple core sample images. At least one of porosity or permeability of the carbonate reservoir is predicted using the identified one or more vugs or fractures in the multiple core sample images.

The previously described implementation is implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium. These and other embodiments may each optionally include one or more of the following features.

In some implementations, the machine learning model is trained using a training set of core sample images, and the machine learning model is validated using a validating set of core sample images, where the validating set of core sample images are different than the training set of core sample images.

In some implementations, the machine learning model is for semantic segmentation of the multiple image patches.

In some implementations, applying the machine learning model to the multiple image patches involves generating, based on the multiple feature classes, multiple label mask images corresponding to the multiple image patches; and identifying the one or more vugs or fractures in the multiple core sample images using the generated multiple label mask images.

In some implementations, the machine learning model includes a convolutional layer, a pooling layer, an upsampling layer, and a dropout layer.

In some implementations, predicting the at least one of porosity or permeability of the carbonate reservoir using the identified one or more vugs or fractures in the multiple core sample images involves predicting a secondary porosity of the carbonate reservoir using the identified one or more vugs or fractures in the multiple core sample images.

In some implementations, predicting the at least one of porosity or permeability of the carbonate reservoir using the identified one or more vugs or fractures in the multiple core sample images includes removing the identified one or more vugs or fractures in the multiple core sample images from the multiple core sample images; and predicting primary porosity of the carbonate reservoir using the multiple core sample images with the identified one or more vugs or fractures removed from the multiple core sample images.

In some implementations, predicting the at least one of porosity or permeability of the carbonate reservoir using the identified one or more vugs or fractures in the multiple core sample images involves identifying, using the identified one or more vugs or fractures in the multiple core sample images, touching vugs, separate vugs, or connected fractures in the multiple core sample images; and predicting effective permeability of the carbonate reservoir using the identified touching vugs, separate vugs, or connected fractures in the multiple core sample images.

In some implementations, the multiple feature classes further include an image background.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 illustrates an example process for identifying and characterizing geologic features of a carbonate reservoir, according to some implementations.

FIG. 2 illustrates example core slab photos with the label annotation overlayed and the corresponding label mask images, according to some implementations.

FIG. 3 illustrates an example process of generating patchy samples by truncating the corresponding core lab images and the associated label mask images, according to some implementations.

FIG. 4 illustrates example patch size sample images of core sample images and the corresponding label mask images, according to some implementations.

FIG. 5 illustrates an example machine learning model for semantic segmentation.

FIGS. 6A and 6B illustrate example training and validation performance, according to some implementations.

FIG. 7 illustrates example performance of vug and fracture prediction on several training and validation examples, according to some implementations.

FIG. 8 illustrates example performance of vug and fracture prediction on several testing examples, according to some implementations.

FIGS. 9A to 9C illustrate fabric selective primary porosity, not fabric selective secondary porosity, and fabric selective or not porosity, respectively, according to some implementations.

FIGS. 10A to 10C illustrate intergranular porosity, vug porosity, and fracture porosity, respectively, according to some implementations.

FIG. 11 illustrates an example joint distribution of the areas of vugs and fractures, according to some implementations.

FIG. 12 illustrates an example process for identifying and characterizing rock element features using core sample images, according to some implementations.

FIG. 13 is a block diagram of an example computer system that can be used to provide computational functionalities associated with described algorithms, methods, functions, processes, flows, and procedures, according to some implementations of the present disclosure.

FIG. 14 illustrates hydrocarbon production operations that include both one or more field operations and one or more computational operations, which exchange information and control exploration for the production of hydrocarbons, according to some implementations.

Like reference numbers and designations in the various drawings indicate like elements.

### DETAILED DESCRIPTION

This disclosure relates to systems and methods for the identification and characterization of geologic features in carbonate reservoirs. The disclosed methods and systems use machine learning for autonomous identification and quantitative characterization of rock element features such as, vugs and fractures from core sample images of a carbonate reservoir. Additionally, the disclosed methods and systems provide prediction of reservoir properties such as porosity, permeability, and rock types in a scale sensitive manner, by using the identified vugs, fractures, and/or other applicable features.

A vug can be a cavity, void, or large pore in a rock that is lined with mineral precipitates. In naturally fractured vuggy carbonate reservoirs, pore types can be classified into three categories: matrices, fractures, and vugs. Rock fabric element features such as vugs and fractures, which can be identified and quantified by microscopic examination of core and cutting samples or borehole images, can be used to characterize the geometric and petrophysical properties of the rock material (e.g., porosity, permeability, water saturation, and characteristic flow behavior). The development in machine learning, especially computer vision technology, can provide an efficient way to improve the process of identifying rock element features and quantifying their areas within sample core or cutting images from reservoir zones.

The disclosed methods and systems provide many advantages over existing systems. Some existing methods and systems for identifying rock element features and quantifying their areas within sample core or cutting images from reservoir zones rely on manual processes and are resource intensive (e.g., time and/or processing power intensive). In contrast, the disclosed methods and systems can autonomously identify vugs and fractures in core sample images, and can quantify the areas of the identified vugs and fractures within sample core or cutting images from reservoir zones. The disclosed methods and systems can do so by applying a machine learning model that has been trained and validated to core sample images. Additionally, the disclosed methods and systems can provide robust performance in predicting reservoir properties such as porosity, permeability, water saturation, and rock types in a scale sensitive manner. This is especially important given that reservoir properties, e.g., carbonate porosity distribution, can be highly scale dependent.

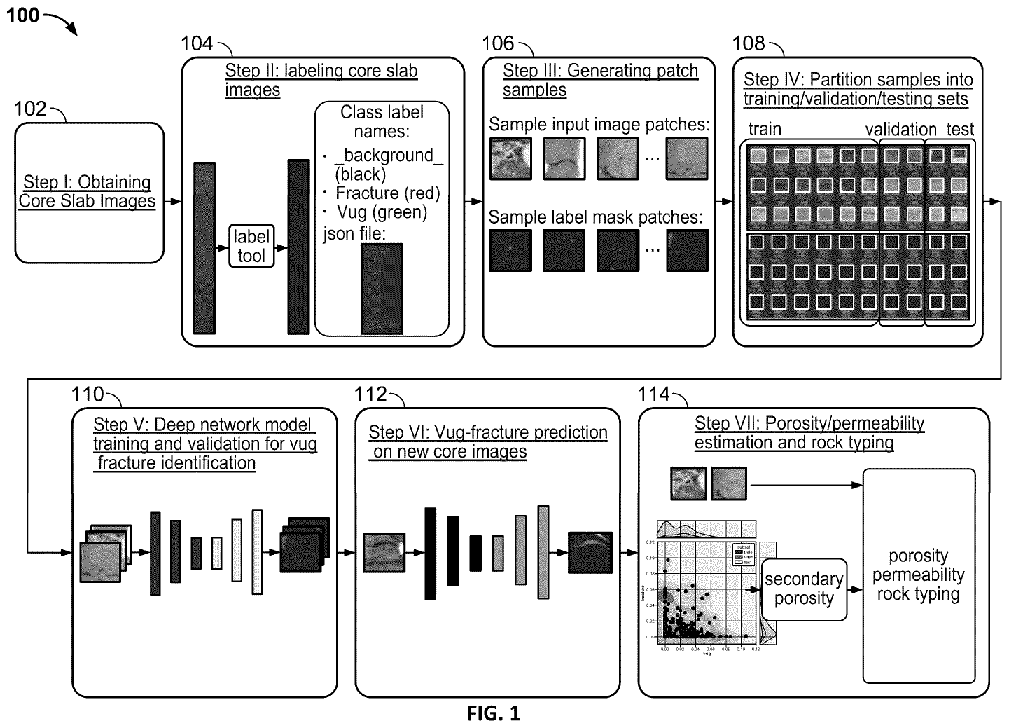

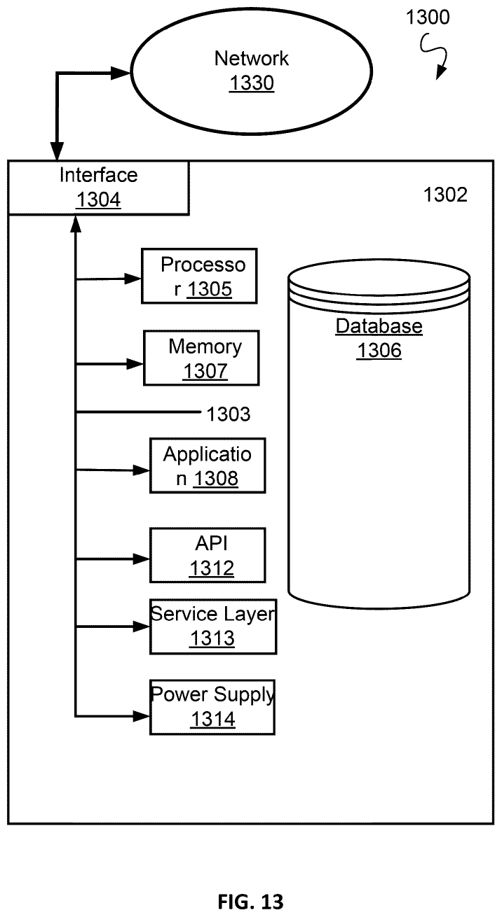

FIG. 1 illustrates an example process 100 for identifying and characterizing geologic features of a carbonate reservoir. For convenience, process 100 will be described as being performed by a computer system having one or more computers located in one or more locations and programmed appropriately in accordance with this specification. An example of the computer system is the computing system 1300 illustrated in FIG. 13 and described below.

At 102, a computer system obtains core sample images. In some implementations, the core sample images can be white light photos taken from core samples, for example, core slabs, of a carbonate reservoir. Additionally or alternatively, the white light photos can be combined with other types of images of core samples from the carbonate reservoir, such as, ultraviolet (UV) light images, images from computerized tomography (CT), images from magnetic resonance imaging (MRI), or hyperspectral images, to generate the core sample images.

In some implementations, the computer system performs the following steps to combine the white light photos with additional types of images if available from the same rock/core samples. First, the computer system aligns and adjusts the images so that they cover the physical areas of the same samples, and resamples the images so that they have the same dimensionality. Then, the computer system combines the images into different channels. The channels can be an extension to the Red, Green, and Blue pixels of a color optical image. Therefore, the same sample can have N₁+N₂+ . . . +Nₖ channels, where Ni is the number of channels for the ith image types, and for i=1, . . . k types of images. Then the computer system feeds the multichannel images into a machine learning network, such as, a convolutional neural network (CNN) (e.g., a U-Net) for segmentation and classification of features in the images. Alternatively, each type of image can have its own network model to map from images to the same output, e.g., identified geological features or predicted properties. And then the output for each image type can be combined to ensure consistency. Different types of image modalities can have different sensitivities to different rock features/properties.

At 104, the computer system labels vugs or fractures on the core sample images obtained from 102. In some implementations, the computer system can use a supervised machine learning (ML) process for identifying vugs or fractures on a core sample image. Example supervised ML processes include semantic and instance segmentation methods, where the labels can include the background of the core sample image, the vugs, or the fractures. The computer system can use a mask image of the same dimensions as the core sample image to label the core sample images such that each pixel on the core sample image belongs to one of the three feature classes: the background of the core sample image, the vugs, or the fractures. For example, the computer system can use a three tuple class mapping [“_background_”: 0, “vug”: 1, “fracture”: 2] to associate the categorical class label names with numerical values of the pixels on the core sample image. For each pixel on the core sample image, the mask image can map the numerical value at the pixel location to the corresponding feature class. Other rock element feature classes, for example, channels, stylolites, burrows, or nodules, can be added as well.

In some implementations, the computer system can use a graphical image annotation tool to implement the aforementioned labeling process. An example graphical image annotation tool is LabelMe®, which is a Python® based image polygonal annotation tool. The graphical image annotation tool can annotate pixel regions that belong to one of the feature classes by enclosing the pixel regions using polygons (or other shapes). The computer system can output the pixels defining each polygon and the corresponding class labels for the pixels inside that polygon to a JSON® file, and then convert the JSON® file into a mask image of the same dimension as the core sample image. In the mask image, the pixels in each polygon take the numerical values defined by the class mapping [“_background_”: 0, “vug”: 1, “fracture”: 2].

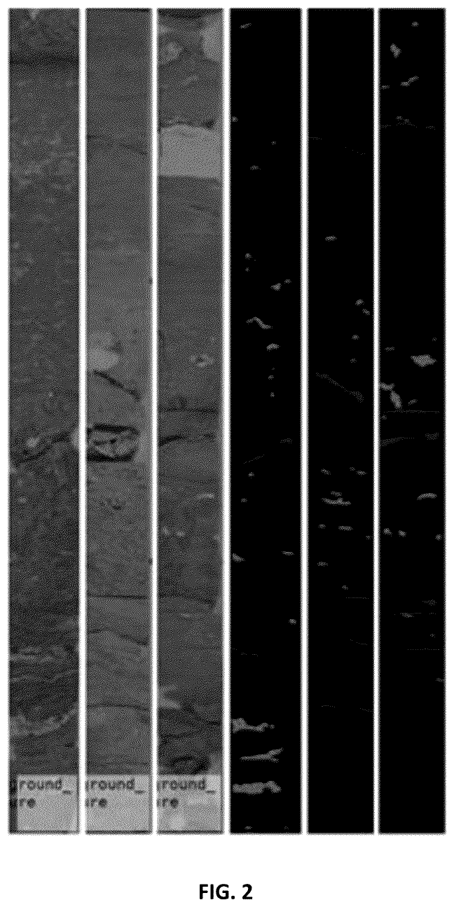

FIG. 2 illustrates example core slab photos and the corresponding label mask images for three different core slabs. The core slab photos, which are the three left-most photos, have the label annotation overlayed. And the corresponding label mask images are the three right-most images. Each of the three mask images include the background, the fractures, and the vugs.

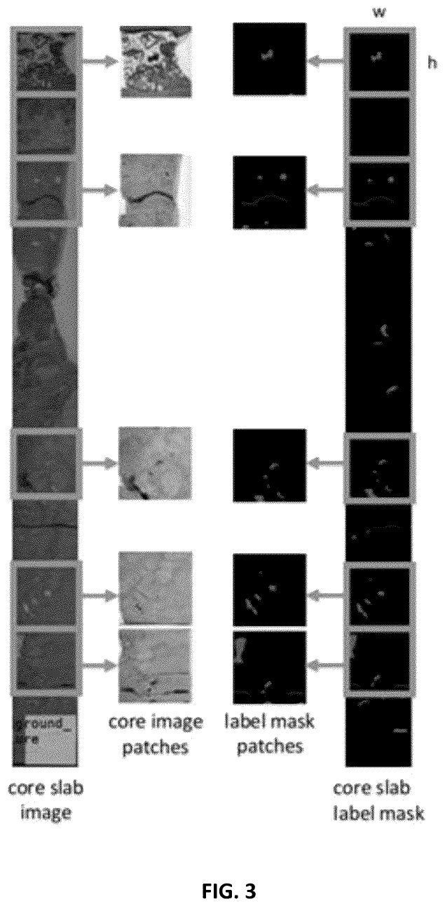

At 106, the computer system truncates the core sample images and mask images generated from 104 to form patchy size sample images, including pairs of core images and the associated mask images of patchy size. Then, the computer system feeds the patchy size sample images into deep network models for segmentation. In some implementations, a core sample image can have a size of hundreds by thousands of pixels and may be too large to be fit into the memory of a deep learning network model for training, and therefore, the core sample image is truncated into patchy size sample images. Additionally, truncating the core sample images into patchy size can generate more images with uniform size. FIG. 3 illustrates an example process of generating patchy samples (images and label masks) by truncating the corresponding core lab images and the associated label mask images.

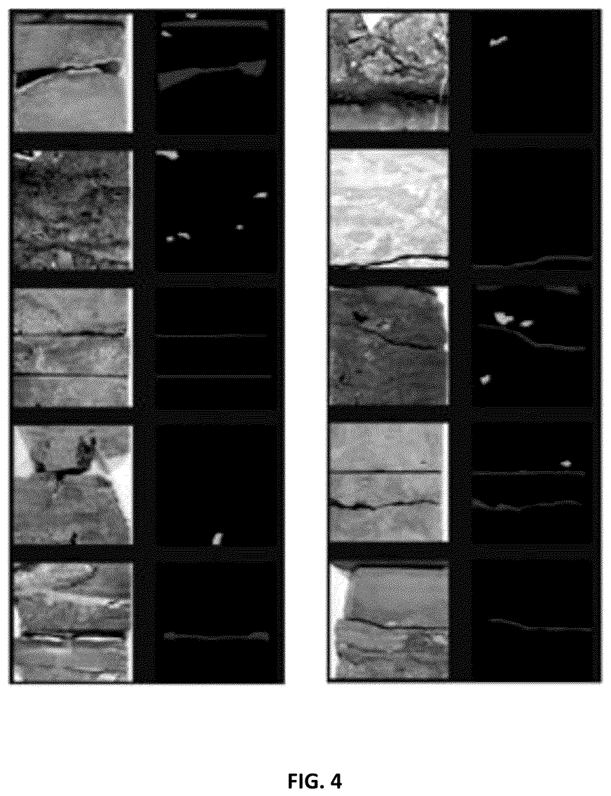

At 108, the computer system augments and partitions the patchy size sample images from 106. In some implementations, the computer system partitions the patchy size sample images into training, validation, and testing subsets, according to certain partition ratio, for example, 65%, 15%, and 20%. The computer system can perform the partitioning of the patchy size sample images by randomly shuffling the indices of the patchy size sample images and then dividing the randomly shuffled indices into the specified partition ratio. The computer system can also sort the vug and fracture distribution in the label mask images for each of the training, validation, and testing subsets of the partitioned patchy size sample images such that the distribution of vugs and fractures for each of the training, validation, and testing subsets is consistent among the three subsets. Therefore, the training, validation and testing subsets can have balanced representation of various characteristics of the core sample images. FIG. 4 illustrates example patch size sample images of core sample images and the corresponding label mask images. The label mask images include identified areas of vugs and fractures.

At 110, the computer system uses machine learning methods to identify vugs and fractures in the augmented and partitioned patchy size sample images from 108. In some implementations, the computer system constructs, trains, and validates machine learning models for semantic or instance segmentation to identify vugs and fractures in the core sample images.

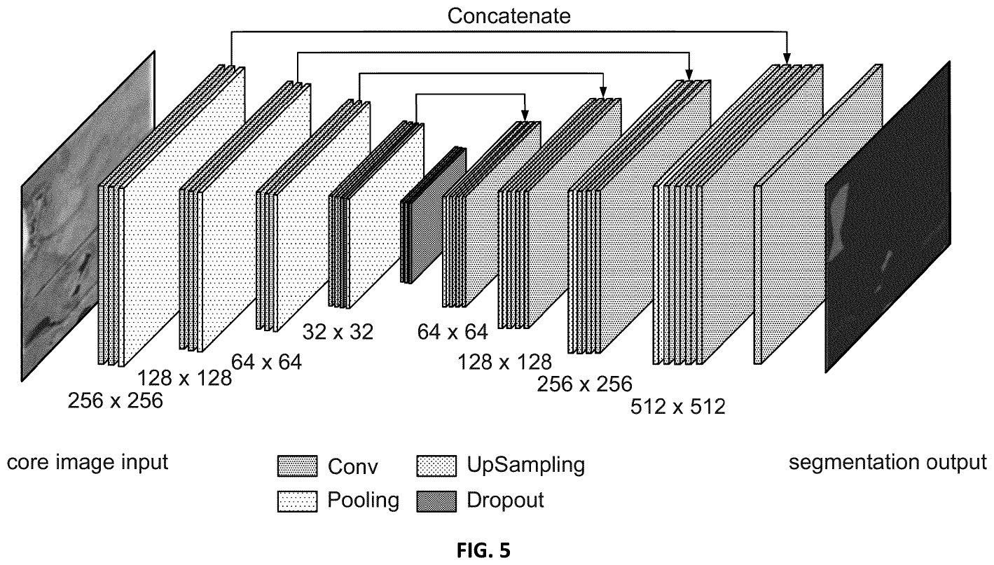

FIG. 5 illustrates an example machine learning model for semantic segmentation. The machine learning model in FIG. 5 includes a U-Net model for semantic segmentation. The network in the machine learning model in FIG. 5 includes four different types of layers including the convolutional layer, the pooling layer, the upsampling layer, and the dropout layer. The network cascades an encoding path (including the first four layer blocks on the left side in FIG. 5) and a decoding path (including the five layer blocks on the right side in FIG. 5) between which the corresponding layers are concatenated via skip connections. The decoding path is followed by a segmentation decision layer to the right. The input to the machine learning model in FIG. 5 is each one of the augmented and partitioned patchy size sample images from 108. And the output of the machine learning model is the prediction of the corresponding label mask image which specifies the feature class label for each pixel. The machine learning model training process determines the network connection weight coefficients throughout the layers such that the difference between the predicted labels and the true labels, averaged over all the training samples from the training subset generated at 108, is minimized.

In some examples, the model loss of the machine learning model is defined as the sum of the weighted Dice loss L_{d} and the categorical focal loss L_{fl}, given as follows in Equations [1] and [2]

$${L}_{d} = 1 - 2 \frac{{\sum }_{l ∈ L} {\sum }_{i ∈ N} {y}_{i}^{( l )} {\hat{y}}_{i}^{( l )} + ε}{{\sum }_{l ∈ L} {\sum }_{i ∈ N} ( {y}_{i}^{( l )} {\hat{y}}_{i}^{( l )} ) + ε} \qquad [ 1 ]$$

$${L}_{fl} = - {\sum }_{i = 1}^{c} {( 1 - {y}_{i} )}^{γ} {t}_{i} log ( {y}_{i} ) . \qquad [ 2 ]$$

In Equations [1] and [2], yᵢ and ŷᵢ are the probability of the ground truth and the predicted class probability, respectively. N and C are the total number of pixels and classes, respectively.

In some implementations, the focal loss L_{fl} down-weights the contribution of easy examples and enables the model to focus more on learning more difficult examples. The model loss can be used for highly imbalanced class scenarios. The Dice loss L_{d} can be derived from the Dice coefficient to calculate the similarity between two images.

In some implementations, easy and difficult examples can be used to represent the level of accuracy in label prediction for the sample pixels of interest. For example, a set of pixels belonging to certain label class that appear commonly across image samples can be trained more often by the model, and therefore, carries more weight in influencing how the network model is adjusted more favorably so that the part of the loss contribution coming from this type of easy examples can be reduced more significantly. Conversely, the pixels belonging to rare label classes can be less trained and carry relatively minor influence, and therefore, the trained model may not produce accurate prediction for this type of pixel classes of difficult examples.

In some implementations, the focal loss is a modified version of binary cross entropy in which the loss for confidently correctly classified labels is scaled down, so that the network focuses more on incorrect and low confidence labels than on increasing its confidence in the already correct labels. Therefore, the difficult examples whose label prediction can be incorrect or of low confidence can carry more weight and are therefore more focused on.

In some implementations, the model loss of the machine learning model can be used to update the network parameters, for example, the weight coefficients in the aforementioned four types of layers in the network, via optimization algorithms, such as, the gradient descent. The gradient descent is described by Equation [3]:

$${w}^{n + 1} = {w}^{n} - ∈ \partial L / \partial w . \qquad [ 3 ]$$

In Equation [3], ϵ is the optimization step size or the learning rate. The evaluation of the gradient ∂L/∂w can be implemented using backpropagation or reverse mode of automatic differentiation, by deep learning framework libraries such as Pytorch® or Tensorflow®.

In some implementations, the intersection of union (IoU) can be used as performance metric of the machine learning model in FIG. 5. The IoU, also known as the Jaccard Index, is the area of overlap between the predicted segmentation and the ground truth divided by the area of union between the predicted segmentation and the ground truth. The IoU can be used for evaluating the performance of the resulting segmentation but not as a loss function during the training because IOU is not differentiable.

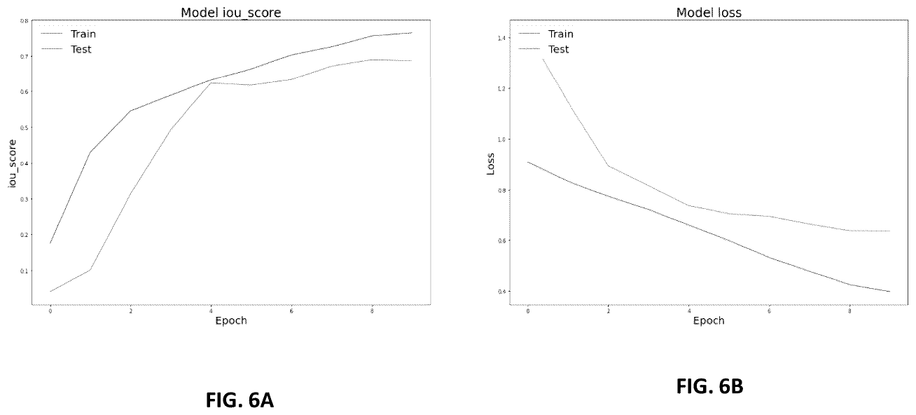

FIGS. 6A and 6B illustrate example training and validation performance in terms of the IoU score (for FIG. 6A) and the model loss (for FIG. 6B). The computer system can stop the training process when the training and validation loss start to bifurcate, for example, the training loss keeps descending and the validation loss plateaus. In the example in FIGS. 6A and 6B, the training process stops at epoch 8.

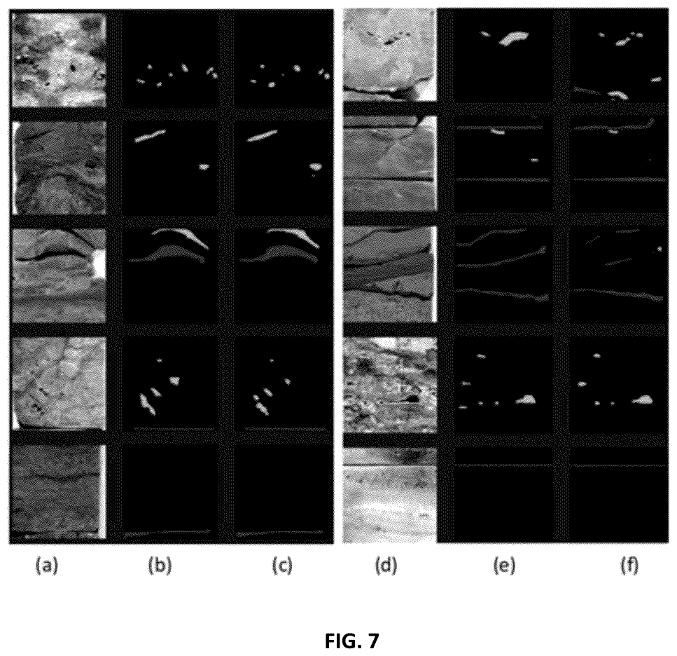

FIG. 7 illustrates an example performance of vug and fracture prediction on several training and validation examples. Subimages a, b, and c of FIG. 7 are the core sample image, the corresponding label mask image, and the predicted label mask image from the machine learning model, respectively, generated using a training subset. Subimages d, e, and f of FIG. 7 are the core sample image, the corresponding label mask image, and the predicted label mask image from the machine learning model, respectively, generated using a validation subset. The training process used to generate the results in FIG. 7 stops at epoch 8. The features in subimages b, c, e, and f include vugs and fractures.

Returning to FIG. 1, at 112, the computer system applies the trained and validated machine learning model from 110 on new core sample images from a testing subset to predict vugs and fractures in the new core sample images. In some implementations, once the segmentation network model has been trained and validated at 110, the computer system can apply it to new core sample images to predict potential vugs and fractures in the new images. First, the computer system preprocesses the new core sample image according to 106 to form patchy size sample images. Then, the computer system feeds the patchy size sample images into the trained machine learning model to generate a prediction of vug and fracture label mask images for the new core sample images. For example, during the training process, the input data to the machine learning model are image patches from a training subset and the output data from the machine learning model are the predicted label masks that are prediction of the respective ground truth label masks, based on the specified loss functions. After the machine learning model is trained, new image patches from the testing subset are provided to the trained machine learning model as input data, and the machine learning model can produce as output the predicted label masks for vugs, fractures, and background of the new image patches from the testing subset.

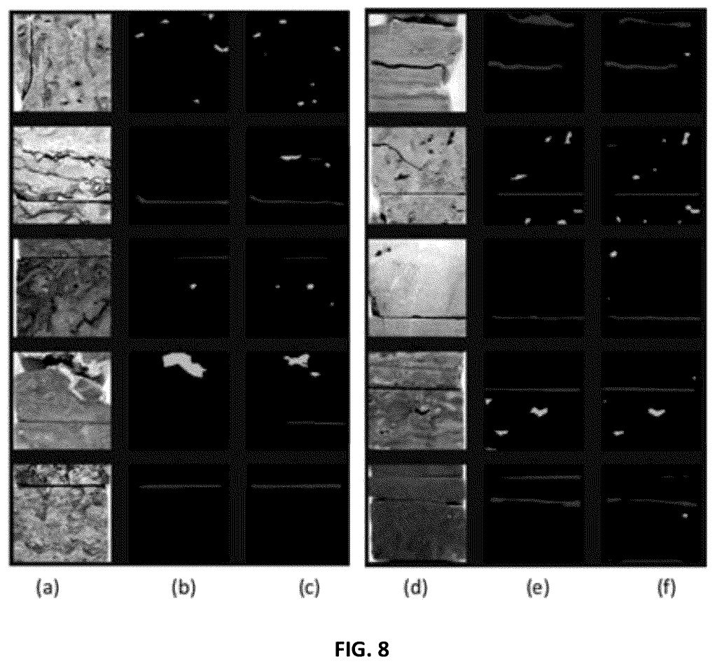

FIG. 8 illustrates example performance of vug and fracture prediction on several testing examples. Subimages a, b, and c of FIG. 8 are the core sample image, the corresponding label mask image, and the predicted label mask image from the machine learning model, respectively, generated using a testing subset. Subimages d, e, and f of FIG. 8 are the core sample image, the corresponding label mask image, and the predicted label mask image from the machine learning model, respectively, generated using another testing subset. The training process used to generate the results in FIG. 8 stops at epoch 8. The features in subimages b, c, e, and f include vugs and fractures.

At 114, the computer system quantitatively characterizes the vugs and fractures identified at 112, combines with the mask corrected core sample images to estimate the primary porosity and permeability, predicts the porosity and permeability in a scale-sensitive manner, and predicts rock types of a reservoir where the new core sample images are taken.

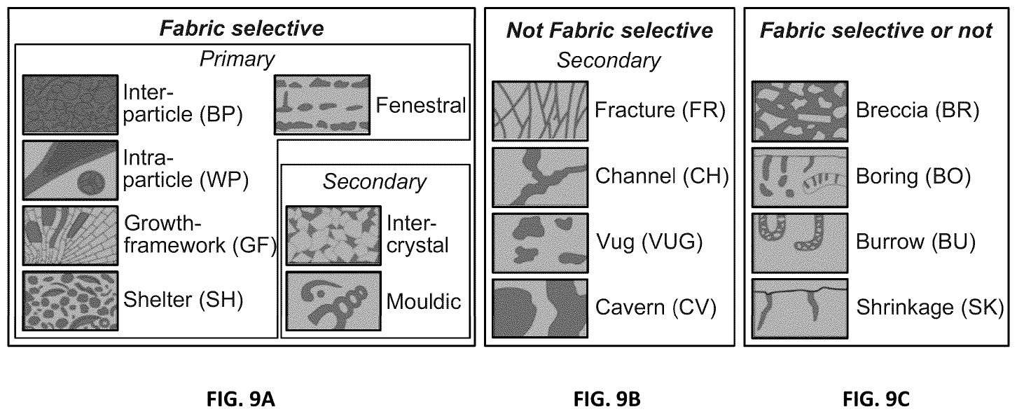

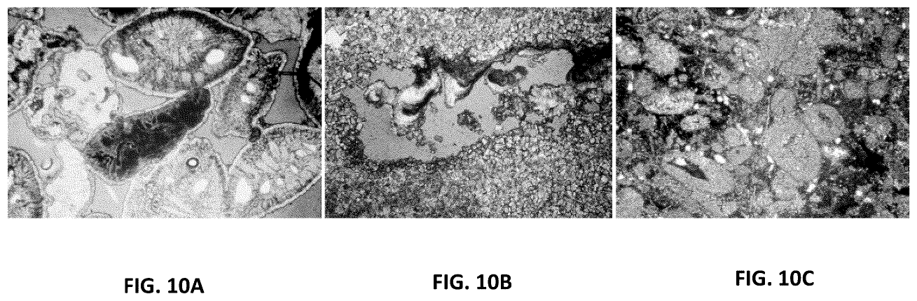

In some implementations, carbonate porosity distribution in a reservoir can be complex due to heterogeneity caused by depositional as well as diagenesis processes. The carbonate porosity distribution can also be highly scale dependent. The pore sizes in carbonate rocks can vary over several orders of magnitude, as governed by both the depositional and post-depositional processes. For example, micropores for muddy rocks with interparticle porosity can have pore size less than 10 microns. Grainy rock with either interparticle or touching-vug porosity can have mesopores size between 50 and 100 microns and macropores size above 100 microns, covering a wide range of scales. The pore space in carbonate rocks can be classified into fabric selective primary porosity such as, inter-particle and intra-particle porosity, fabric selective secondary porosity (e.g., inter-crystal and moldic porosity), not fabric selective secondary porosity (e.g., fractures, channels, vugs, or caverns), and other porosity (e.g., breccia or burrow). These classifications are shown in FIGS. 9A to 9C and 10A to 10C. FIGS. 9A to 9C illustrate fabric selective primary porosity, not fabric selective secondary porosity, and fabric selective or not porosity, respectively. FIGS. 10A to 10C illustrate intergranular porosity, vug porosity, and fracture porosity, respectively.

In some implementations, the fracture and vuggy pore space can have a greater influence on the secondary porosity and can exhibit different characteristics than those of fabric selective pore space. The machine learning based vug and fracture identification method illustrated in FIG. 1 can provide a multi-stage workflow where the dominant secondary porosity can be extracted from the identified vug and fracture features in the core sample image. The computer system can then use the corrected background in the core sample images, for example, the core sample images with the areas associated with the vugs and fractures removed, to extract the primary porosity by using methods that are consistent with relatively homogeneous conditions of the background in the core sample images. For example, the dominant secondary porosity can be calculated using the area sum of the identified vugs and fractures as a percentage of the total image area. Additionally, the primary porosity describes the pore spaces between grains that are formed during depositional processes (e.g., sedimentation and diagenesis), and secondary porosity is formed from post-depositional processes (e.g., dissolution, reprecipitation, and fracturing). Therefore, once the dominant secondary porosity has been determined, the computer system can remove the area corresponding to the label masks representing the dominant secondary porosity, and can compute the primary porosity associated with grain gaps on the remaining image pixels, given a homogeneous background.

In some implementations, the computer system can use the identified vugs and fractures to further identify touching vugs, separate vugs, or connected fractures. The computer system can then use the identified touching vugs, separate vugs, or connected fractures to quantify effective permeability. For example, after the segmentation network model generates vugs and fractures label masks across each input image patch, the computer system can apply connected component analysis to identify connected components, because all pixels in a connected component share the same class label. The computer system can also identify touched components because the touched components belong to either vug or fracture label (not background), and are spatially connected in adjacency, which can be determined by the computer system using a neighborhood pixel class scan.

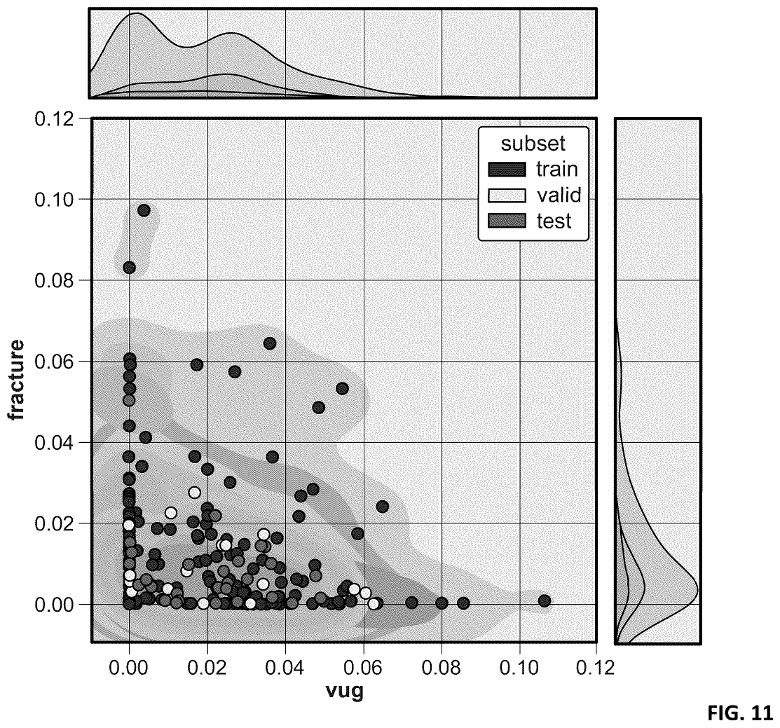

In some implementations, the computer system can characterize the vugs and fractures, for example, in terms of the areas of the identified features and their joint distribution, and determine rock types of a reservoir using the areas of the identified features and their joint distribution. The areas of the identified vugs and fractures can be determined based on the number of pixels in the corresponding features in the label mask images. The distribution pattern and population percentage of vugs and fractures within a certain depth range or from different wells are characteristics of various rock types, for example, lithological petrophysical (LPRT) and petrophysical (PRT) types of carbonate rocks, which are both dependent on pore space characterization related to vuggy and fractured-porous distribution. FIG. 11 illustrates an example joint distribution of the areas of vugs and fractures in the training, validation, and testing subsets and identified using the machine learning method shown in FIG. 1.

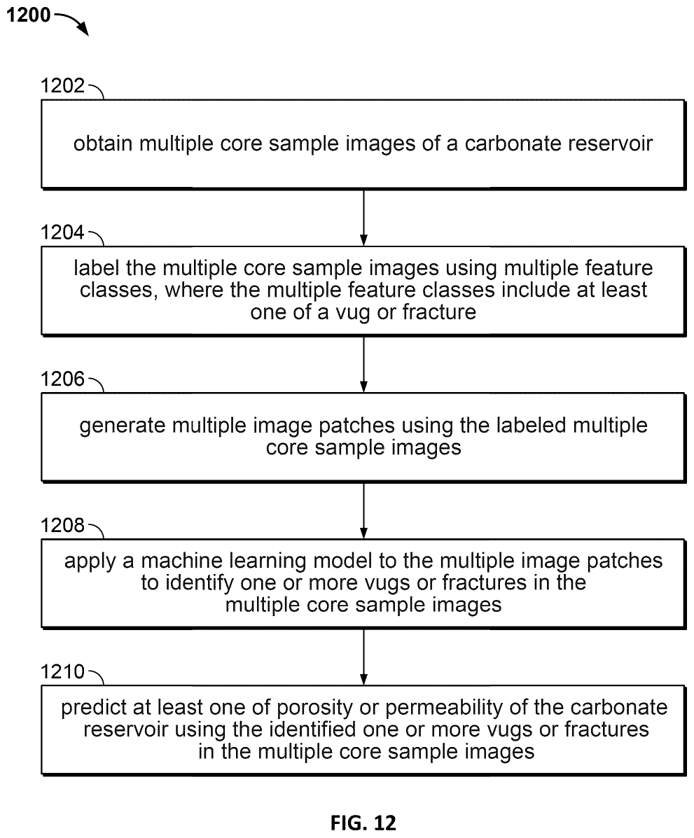

FIG. 12 illustrates an example process 1200 for identifying and characterizing rock element features using core sample images. For convenience, process 1200 will be described as being performed by a computer system having one or more computers located in one or more locations and programmed appropriately in accordance with this specification. An example of the computer system is the computing system 1300 illustrated in FIG. 13 and described below.

At step 1202, a computer system obtains multiple core sample images of a carbonate reservoir.

At step 1204, the computer system labels the multiple core sample images using multiple feature classes, where the multiple feature classes include at least one of a vug or fracture.

At step 1206, the computer system generates multiple image patches using the labeled multiple core sample images.

At step 1208, the computer system applies a machine learning model to the multiple image patches to identify one or more vugs or fractures in the multiple core sample images.

At step 1210, the computer system predicts at least one of porosity or permeability of the carbonate reservoir using the identified one or more vugs or fractures in the multiple core sample images.

FIG. 13 is a block diagram of an example computer system 1300 that can be used to provide computational functionalities associated with described algorithms, methods, functions, processes, flows, and procedures, according to some implementations of the present disclosure. In some implementations, the computer system performing process 100 or 1200 can be the computer system 1300, include the computer system 1300, or the computer system performing process 100 or 1200 can communicate with the computer system 1300.

The illustrated computer 1302 is intended to encompass any computing device such as a server, a desktop computer, an embedded computer, a laptop/notebook computer, a wireless data port, a smart phone, a personal data assistant (PDA), a tablet computing device, or one or more processors within these devices, including physical instances, virtual instances, or both. The computer 1302 can include input devices such as keypads, keyboards, and touch screens that can accept user information. Also, the computer 1302 can include output devices that can convey information associated with the operation of the computer 1302. The information can include digital data, visual data, audio information, or a combination of information. The information can be presented in a graphical user interface (UI) (or GUI). In some implementations, the inputs and outputs include display ports (such as DVI-I+2× display ports), USB 3.0, GbE ports, isolated DI/O, SATA-III (6.0 Gb/s) ports, mPCIe slots, a combination of these, or other ports. In instances of an edge gateway, the computer 1302 can include a Smart Embedded Management Agent (SEMA), such as a built-in ADLINK SEMA 2.2, and a video sync technology, such as Quick Sync Video technology supported by ADLINK MSDK+. In some examples, the computer 1302 can include the MXE-5400 Series processor-based fanless embedded computer by ADLINK, though the computer 1302 can take other forms or include other components.

The computer 1302 can serve in a role as a client, a network component, a server, a database, a persistency, or components of a computer system for performing the subject matter described in the present disclosure. The illustrated computer 1302 is communicably coupled with a network 1330. In some implementations, one or more components of the computer 1302 can be configured to operate within different environments, including cloud-computing-based environments, local environments, global environments, and combinations of environments.

At a high level, the computer 1302 is an electronic computing device operable to receive, transmit, process, store, and manage data and information associated with the described subject matter. According to some implementations, the computer 1302 can also include, or be communicably coupled with, an application server, an email server, a web server, a caching server, a streaming data server, or a combination of servers.

The computer 1302 can receive requests over network 1330 from a client application (for example, executing on another computer 1302). The computer 1302 can respond to the received requests by processing the received requests using software applications. Requests can also be sent to the computer 1302 from internal users (for example, from a command console), external (or third) parties, automated applications, entities, individuals, systems, and computers.

Each of the components of the computer 1302 can communicate using a system bus 1303. In some implementations, any or all of the components of the computer 1302, including hardware or software components, can interface with each other or the interface 1304 (or a combination of both), over the system bus. Interfaces can use an application programming interface (API) 1312, a service layer 1313, or a combination of the API 1312 and service layer 1313. The API 1312 can include specifications for routines, data structures, and object classes. The API 1312 can be either computer-language independent or dependent. The API 1312 can refer to a complete interface, a single function, or a set of APIs 1312.

The service layer 1313 can provide software services to the computer 1302 and other components (whether illustrated or not) that are communicably coupled to the computer 1302. The functionality of the computer 1302 can be accessible for all service consumers using this service layer 1313. Software services, such as those provided by the service layer 1313, can provide reusable, defined functionalities through a defined interface. For example, the interface can be software written in JAVA, C++, or a language providing data in extensible markup language (XML) format. While illustrated as an integrated component of the computer 1302, in alternative implementations, the API 1312 or the service layer 1313 can be stand-alone components in relation to other components of the computer 1302 and other components communicably coupled to the computer 1302. Moreover, any or all parts of the API 1312 or the service layer 1313 can be implemented as child or sub-modules of another software module, enterprise application, or hardware module without departing from the scope of the present disclosure.

The computer 1302 can include an interface 1304. Although illustrated as a single interface 1304 in FIG. 13, two or more interfaces 1304 can be used according to particular needs, desires, or particular implementations of the computer 1302 and the described functionality. The interface 1304 can be used by the computer 1302 for communicating with other systems that are connected to the network 1330 (whether illustrated or not) in a distributed environment. Generally, the interface 1304 can include, or be implemented using, logic encoded in software or hardware (or a combination of software and hardware) operable to communicate with the network 1330. More specifically, the interface 1304 can include software supporting one or more communication protocols associated with communications. As such, the network 1330 or the interface's hardware can be operable to communicate physical signals within and outside of the illustrated computer 1302.

The computer 1302 includes a processor 1305. Although illustrated as a single processor 1305 in FIG. 13, two or more processors 1305 can be used according to particular needs, desires, or particular implementations of the computer 1302 and the described functionality. Generally, the processor 1305 can execute instructions and manipulate data to perform the operations of the computer 1302, including operations using algorithms, methods, functions, processes, flows, and procedures as described in the present disclosure.

The computer 1302 can also include a database 1306 that can hold data for the computer 1302 and other components connected to the network 1330 (whether illustrated or not). For example, database 1306 can be an in-memory, conventional, or a database storing data consistent with the present disclosure. In some implementations, the database 1306 can be a combination of two or more different database types (for example, hybrid in-memory and conventional databases) according to particular needs, desires, or particular implementations of the computer 1302 and the described functionality. Although illustrated as a single database 1306 in FIG. 13, two or more databases (of the same, different, or combination of types) can be used according to particular needs, desires, or particular implementations of the computer 1302 and the described functionality. While database 1306 is illustrated as an internal component of the computer 1302, in alternative implementations, database 1306 can be external to the computer 1302.

The computer 1302 also includes a memory 1307 that can hold data for the computer 1302 or a combination of components connected to the network 1330 (whether illustrated or not). Memory 1307 can store any data consistent with the present disclosure. In some implementations, memory 1307 can be a combination of two or more different types of memory (for example, a combination of semiconductor and magnetic storage) according to particular needs, desires, or particular implementations of the computer 1302 and the described functionality. Although illustrated as a single memory 1307 in FIG. 13, two or more memories 1307 (of the same, different, or combination of types) can be used according to particular needs, desires, or particular implementations of the computer 1302 and the described functionality. While memory 1307 is illustrated as an internal component of the computer 1302, in alternative implementations, memory 1307 can be external to the computer 1302.

An application 1308 can be an algorithmic software engine providing functionality according to particular needs, desires, or particular implementations of the computer 1302 and the described functionality. For example, an application 1308 can serve as one or more components, modules, or applications 1308. Multiple applications 1308 can be implemented on the computer 1302. Each application 1308 can be internal or external to the computer 1302.

The computer 1302 can also include a power supply 1314. The power supply 1314 can include a rechargeable or non-rechargeable battery that can be configured to be either user- or non-user-replaceable. In some implementations, the power supply 1314 can include power-conversion and management circuits, including recharging, standby, and power management functionalities. In some implementations, the power-supply 1314 can include a power plug to allow the computer 1302 to be plugged into a wall socket or a power source to, for example, power the computer 1302 or recharge a rechargeable battery.

There can be any number of computers 1302 associated with, or external to, a computer system including computer 1302, with each computer 1302 communicating over network 1330. Further, the terms “client”, “user”, and other appropriate terminology can be used interchangeably without departing from the scope of the present disclosure. Moreover, the present disclosure contemplates that many users can use one computer 1302 and one user can use multiple computers 1302.

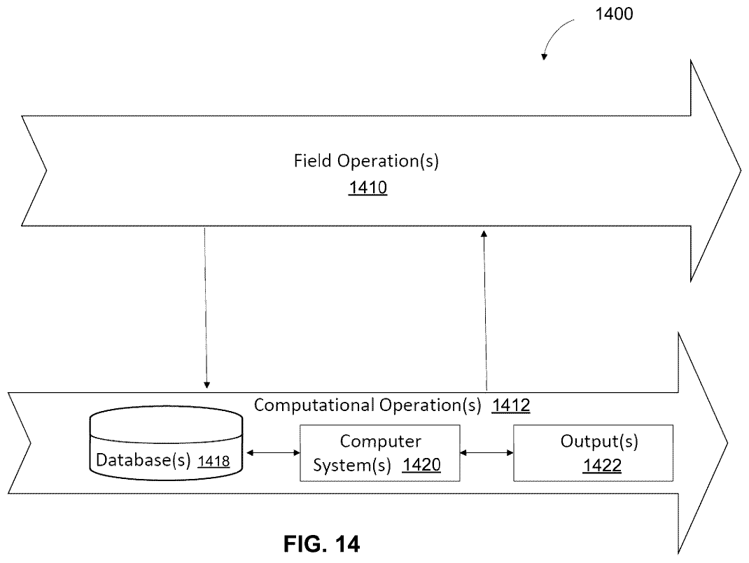

FIG. 14 illustrates hydrocarbon production operations 1400 that include both one or more field operations 1410 and one or more computational operations 1412, which exchange information and control exploration for the production of hydrocarbons. In some implementations, outputs of techniques of the present disclosure can be performed before, during, or in combination with the hydrocarbon production operations 1400, specifically, for example, either as field operations 1410 or computational operations 1412, or both.

Examples of field operations 1410 include forming/drilling a wellbore, hydraulic fracturing, producing through the wellbore, injecting fluids (such as water) through the wellbore, to name a few. In some implementations, methods of the present disclosure can trigger or control the field operations 1410. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 1410 and responsively triggering the field operations 1410 including, for example, generating plans and signals that provide feedback to and control physical components of the field operations 1410. Alternatively or in addition, the field operations 1410 can trigger the methods of the present disclosure. For example, implementing physical components (including, for example, hardware, such as sensors) deployed in the field operations 1410 can generate plans and signals that can be provided as input or feedback (or both) to the methods of the present disclosure.

Examples of computational operations 1412 include one or more computer systems 1420 that include one or more processors and computer-readable media (e.g., non-transitory computer-readable media) operatively coupled to the one or more processors to execute computer operations to perform the methods of the present disclosure. The computational operations 1412 can be implemented using one or more databases 1418, which store data received from the field operations 1410 and/or generated internally within the computational operations 1412 (e.g., by implementing the methods of the present disclosure) or both. For example, the one or more computer systems 1420 process inputs from the field operations 1410 to assess conditions in the physical world, the outputs of which are stored in the databases 1418. For example, seismic sensors of the field operations 1410 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 1412 where they are stored in the databases 1418 and analyzed by the one or more computer systems 1420.

In some implementations, one or more outputs 1422 generated by the one or more computer systems 1420 can be provided as feedback/input to the field operations 1410 (either as direct input or stored in the databases 1418). The field operations 1410 can use the feedback/input to control physical components used to perform the field operations 1410 in the real world.

For example, the computational operations 1412 can process the seismic data to generate three-dimensional (3D) maps of the subsurface formation. The computational operations 1412 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 1412 to process new information about the formation and control the drilling to adjust to the observed conditions in real-time.

The one or more computer systems 1420 can update the 3D maps of the subsurface formation as information from one exploration well is received and the computational operations 1412 can adjust the location of the next exploration well based on the updated 3D maps. Similarly, the data received from production operations can be used by the computational operations 1412 to control components of the production operations. For example, production well and pipeline data can be analyzed to predict slugging in pipelines leading to a refinery and the computational operations 1412 can control machine operated valves upstream of the refinery to reduce the likelihood of plant disruptions that run the risk of taking the plant offline.

In some implementations of the computational operations 1412, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

Certain aspects of the subject matter described here can be implemented as a method. The method includes obtaining multiple core sample images of a carbonate reservoir. The multiple core sample images are labeled using multiple feature classes, where the multiple feature classes include at least one of a vug or fracture. Multiple image patches are generated using the labeled plurality of core sample images. A machine learning model is applied to the multiple image patches to identify one or more vugs or fractures in the multiple core sample images. At least one of porosity or permeability of the carbonate reservoir is predicted using the identified one or more vugs or fractures in the multiple core sample images.

An aspect taken alone or combinable with any other aspect includes the following features. The machine learning model is trained using a training set of core sample images, and the machine learning model is validated using a validating set of core sample images, where the validating set of core sample images are different than the training set of core sample images.

An aspect taken alone or combinable with any other aspect includes the following features. The machine learning model is for semantic segmentation of the multiple image patches.

An aspect taken alone or combinable with any other aspect includes the following features. Applying the machine learning model to the multiple image patches involves generating, based on the multiple feature classes, multiple label mask images corresponding to the multiple image patches; and identifying the one or more vugs or fractures in the multiple core sample images using the generated multiple label mask images.

An aspect taken alone or combinable with any other aspect includes the following features. The machine learning model includes a convolutional layer, a pooling layer, an upsampling layer, and a dropout layer.

An aspect taken alone or combinable with any other aspect includes the following features. Predicting the at least one of porosity or permeability of the carbonate reservoir using the identified one or more vugs or fractures in the multiple core sample images involves predicting a secondary porosity of the carbonate reservoir using the identified one or more vugs or fractures in the multiple core sample images.

An aspect taken alone or combinable with any other aspect includes the following features. Predicting the at least one of porosity or permeability of the carbonate reservoir using the identified one or more vugs or fractures in the multiple core sample images includes removing the identified one or more vugs or fractures in the multiple core sample images from the multiple core sample images; and predicting primary porosity of the carbonate reservoir using the multiple core sample images with the identified one or more vugs or fractures removed from the multiple core sample images.

An aspect taken alone or combinable with any other aspect includes the following features. Predicting the at least one of porosity or permeability of the carbonate reservoir using the identified one or more vugs or fractures in the multiple core sample images involves identifying, using the identified one or more vugs or fractures in the multiple core sample images, touching vugs, separate vugs, or connected fractures in the multiple core sample images; and predicting effective permeability of the carbonate reservoir using the identified touching vugs, separate vugs, or connected fractures in the multiple core sample images.

An aspect taken alone or combinable with any other aspect includes the following features. The multiple feature classes further include an image background.

Certain aspects of the subject matter described in this disclosure can be implemented as a non-transitory computer-readable medium storing instructions which, when executed by a hardware-based processor perform operations including the methods described here.

Certain aspects of the subject matter described in this disclosure can be implemented as a computer-implemented system that includes one or more processors including a hardware-based processor, and a memory storage including a non-transitory computer-readable medium storing instructions which, when executed by the one or more processors, performs one or more operations including the methods described here.

Implementations of the subject matter and the functional operations described in this specification can be implemented in digital electronic circuitry, in tangibly embodied computer software or firmware; in computer hardware, including the structures disclosed in this specification and their structural equivalents; or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus”, “computer”, and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus and special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, Linux, Unix, Windows, Mac OS, Android, or iOS.

A computer program, which can also be referred to or described as a program, software, a software application, a module, a software module, a script, or code can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document; in a single file dedicated to the program in question; or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes; the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks, optical memory devices, and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), or a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser. Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, or in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations; and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

### Embodiments

Embodiment 1: A computer-implemented method comprising obtaining a plurality of core sample images of a carbonate reservoir; labeling the plurality of core sample images using a plurality of feature classes, wherein the plurality of feature classes comprise at least one of a vug or fracture; generating a plurality of image patches using the labeled plurality of core sample images; applying a machine learning model to the plurality of image patches to identify one or more vugs or fractures in the plurality of core sample images; and predicting at least one of porosity or permeability of the carbonate reservoir using the identified one or more vugs or fractures in the plurality of core sample images.

Embodiment 2: The computer-implemented method of embodiment 1, wherein the computer-implemented method further comprises training the machine learning model using a training set of core sample images; and validating the machine learning model using a validating set of core sample images, wherein the validating set of core sample images are different than the training set of core sample images.

Embodiment 3: The computer-implemented method of embodiment 1 or 2, wherein the machine learning model is for semantic segmentation of the plurality of image patches.

Embodiment 4: The computer-implemented method of any one of embodiments 1 to 3, wherein applying the machine learning model to the plurality of image patches comprises generating, based on the plurality of feature classes, a plurality of label mask images corresponding to the plurality of image patches; and identifying the one or more vugs or fractures in the plurality of core sample images using the generated plurality of label mask images.

Embodiment 5: The computer-implemented method of any one of embodiments 1 to 4, wherein the machine learning model comprises a convolutional layer, a pooling layer, an upsampling layer, and a dropout layer.

Embodiment 6: The computer-implemented method of any one of embodiments 1 to 5, wherein predicting the at least one of porosity or permeability of the carbonate reservoir using the identified one or more vugs or fractures in the plurality of core sample images comprises predicting a secondary porosity of the carbonate reservoir using the identified one or more vugs or fractures in the plurality of core sample images.

Embodiment 7: The computer-implemented method of any one of embodiments 1 to 6, wherein predicting the at least one of porosity or permeability of the carbonate reservoir using the identified one or more vugs or fractures in the plurality of core sample images comprises removing the identified one or more vugs or fractures in the plurality of core sample images from the plurality of core sample images; and predicting primary porosity of the carbonate reservoir using the plurality of core sample images with the identified one or more vugs or fractures removed from the plurality of core sample images.

Embodiment 8: The computer-implemented method of any one of embodiments 1 to 7, wherein predicting the at least one of porosity or permeability of the carbonate reservoir using the identified one or more vugs or fractures in the plurality of core sample images comprises identifying, using the identified one or more vugs or fractures in the plurality of core sample images, touching vugs, separate vugs, or connected fractures in the plurality of core sample images; and predicting effective permeability of the carbonate reservoir using the identified touching vugs, separate vugs, or connected fractures in the plurality of core sample images.

Embodiment 9: The computer-implemented method of any one of embodiments 1 to 8, wherein the plurality of feature classes further comprise an image background.

Embodiment 10: A non-transitory computer-readable medium storing one or more instructions executable by a computer system to perform operations comprising obtaining a plurality of core sample images of a carbonate reservoir; labeling the plurality of core sample images using a plurality of feature classes, wherein the plurality of feature classes comprise at least one of a vug or fracture; generating a plurality of image patches using the labeled plurality of core sample images; applying a machine learning model to the plurality of image patches to identify one or more vugs or fractures in the plurality of core sample images; and predicting at least one of porosity or permeability of the carbonate reservoir using the identified one or more vugs or fractures in the plurality of core sample images.

Embodiment 11: The non-transitory computer-readable medium of embodiment 10, wherein the operations further comprise training the machine learning model using a training set of core sample images; and validating the machine learning model using a validating set of core sample images, wherein the validating set of core sample images are different than the training set of core sample images.

Embodiment 12: The non-transitory computer-readable medium of embodiment 10 or 11, wherein the machine learning model is for semantic segmentation of the plurality of image patches.

Embodiment 13: The non-transitory computer-readable medium of embodiment 10, wherein applying the machine learning model to the plurality of image patches comprises generating, based on the plurality of feature classes, a plurality of label mask images corresponding to the plurality of image patches; and identifying the one or more vugs or fractures in the plurality of core sample images using the generated plurality of label mask images.

Embodiment 14: The non-transitory computer-readable medium of any one of embodiments 10 to 13, wherein the machine learning model comprises a convolutional layer, a pooling layer, an upsampling layer, and a dropout layer.

Embodiment 15: The non-transitory computer-readable medium of any one of embodiments 10 to 14, wherein predicting the at least one of porosity or permeability of the carbonate reservoir using the identified one or more vugs or fractures in the plurality of core sample images comprises predicting a secondary porosity of the carbonate reservoir using the identified one or more vugs or fractures in the plurality of core sample images.

Embodiment 16: A computer-implemented system, comprising one or more computers; and one or more computer memory devices interoperably coupled with the one or more computers and having tangible, non-transitory, machine-readable media storing one or more instructions that, when executed by the one or more computers, perform one or more operations comprising obtaining a plurality of core sample images of a carbonate reservoir; labeling the plurality of core sample images using a plurality of feature classes, wherein the plurality of feature classes comprise at least one of a vug or fracture; generating a plurality of image patches using the labeled plurality of core sample images; applying a machine learning model to the plurality of image patches to identify one or more vugs or fractures in the plurality of core sample images; and predicting at least one of porosity or permeability of the carbonate reservoir using the identified one or more vugs or fractures in the plurality of core sample images.

Embodiment 17: The computer-implemented system of embodiment 16, wherein the one or more operations further comprise training the machine learning model using a training set of core sample images; and validating the machine learning model using a validating set of core sample images, wherein the validating set of core sample images are different than the training set of core sample images.

Embodiment 18: The computer-implemented system of embodiment 16 or 17, wherein the machine learning model is for semantic segmentation of the plurality of image patches.

Embodiment 19: The computer-implemented system of any one of embodiments 16 to 18, wherein applying the machine learning model to the plurality of image patches comprises generating, based on the plurality of feature classes, a plurality of label mask images corresponding to the plurality of image patches; and identifying the one or more vugs or fractures in the plurality of core sample images using the generated plurality of label mask images.

Embodiment 20: The computer-implemented system of any one of embodiments 16 to 19, wherein the machine learning model comprises a convolutional layer, a pooling layer, an upsampling layer, and a dropout layer.

We claim:

1. A computer-implemented method comprising:
obtaining a plurality of core sample images of a carbonate reservoir;
labeling the plurality of core sample images using a plurality of feature classes, wherein the plurality of feature classes comprise at least one of a vug or fracture;
generating a plurality of image patches using the labeled plurality of core sample images;
applying a machine learning model to the plurality of image patches to identify one or more vugs or fractures in the plurality of core sample images; and
predicting at least one of porosity or permeability of the carbonate reservoir using the identified one or more vugs or fractures in the plurality of core sample images.

2. The computer-implemented method of claim 1, wherein the computer-implemented method further comprises:
training the machine learning model using a training set of core sample images; and
validating the machine learning model using a validating set of core sample images, wherein the validating set of core sample images are different than the training set of core sample images.

3. The computer-implemented method of claim 1, wherein the machine learning model is for semantic segmentation of the plurality of image patches.

4. The computer-implemented method of claim 1, wherein applying the machine learning model to the plurality of image patches comprises:
generating, based on the plurality of feature classes, a plurality of label mask images corresponding to the plurality of image patches; and
identifying the one or more vugs or fractures in the plurality of core sample images using the generated plurality of label mask images.

5. The computer-implemented method of claim 1, wherein the machine learning model comprises a convolutional layer, a pooling layer, an upsampling layer, and a dropout layer.

6. The computer-implemented method of claim 1, wherein predicting the at least one of porosity or permeability of the carbonate reservoir using the identified one or more vugs or fractures in the plurality of core sample images comprises:
predicting a secondary porosity of the carbonate reservoir using the identified one or more vugs or fractures in the plurality of core sample images.

7. The computer-implemented method of claim 1, wherein predicting the at least one of porosity or permeability of the carbonate reservoir using the identified one or more vugs or fractures in the plurality of core sample images comprises:
removing the identified one or more vugs or fractures in the plurality of core sample images from the plurality of core sample images; and
predicting primary porosity of the carbonate reservoir using the plurality of core sample images with the identified one or more vugs or fractures removed from the plurality of core sample images.

8. The computer-implemented method of claim 1, wherein predicting the at least one of porosity or permeability of the carbonate reservoir using the identified one or more vugs or fractures in the plurality of core sample images comprises:
identifying, using the identified one or more vugs or fractures in the plurality of core sample images, touching vugs, separate vugs, or connected fractures in the plurality of core sample images; and
predicting effective permeability of the carbonate reservoir using the identified touching vugs, separate vugs, or connected fractures in the plurality of core sample images.

9. The computer-implemented method of claim 1, wherein the plurality of feature classes further comprise an image background.

10. A non-transitory computer-readable medium storing one or more instructions executable by a computer system to perform operations comprising:
obtaining a plurality of core sample images of a carbonate reservoir;
labeling the plurality of core sample images using a plurality of feature classes, wherein the plurality of feature classes comprise at least one of a vug or fracture;
generating a plurality of image patches using the labeled plurality of core sample images;
applying a machine learning model to the plurality of image patches to identify one or more vugs or fractures in the plurality of core sample images; and
predicting at least one of porosity or permeability of the carbonate reservoir using the identified one or more vugs or fractures in the plurality of core sample images.

11. The non-transitory computer-readable medium of claim 10, wherein the operations further comprise:
training the machine learning model using a training set of core sample images; and
validating the machine learning model using a validating set of core sample images, wherein the validating set of core sample images are different than the training set of core sample images.

12. The non-transitory computer-readable medium of claim 10, wherein the machine learning model is for semantic segmentation of the plurality of image patches.

13. The non-transitory computer-readable medium of claim 10, wherein applying the machine learning model to the plurality of image patches comprises:
generating, based on the plurality of feature classes, a plurality of label mask images corresponding to the plurality of image patches; and
identifying the one or more vugs or fractures in the plurality of core sample images using the generated plurality of label mask images.

14. The non-transitory computer-readable medium of claim 10, wherein the machine learning model comprises a convolutional layer, a pooling layer, an upsampling layer, and a dropout layer.

15. The non-transitory computer-readable medium of claim 10, wherein predicting the at least one of porosity or permeability of the carbonate reservoir using the identified one or more vugs or fractures in the plurality of core sample images comprises:
predicting a secondary porosity of the carbonate reservoir using the identified one or more vugs or fractures in the plurality of core sample images.

16. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
obtaining a plurality of core sample images of a carbonate reservoir;
labeling the plurality of core sample images using a plurality of feature classes, wherein the plurality of feature classes comprise at least one of a vug or fracture;
generating a plurality of image patches using the labeled plurality of core sample images;
applying a machine learning model to the plurality of image patches to identify one or more vugs or fractures in the plurality of core sample images; and
predicting at least one of porosity or permeability of the carbonate reservoir using the identified one or more vugs or fractures in the plurality of core sample images.

17. The computer-implemented system of claim 16, wherein the one or more operations further comprise:
training the machine learning model using a training set of core sample images; and
validating the machine learning model using a validating set of core sample images, wherein the validating set of core sample images are different than the training set of core sample images.

18. The computer-implemented system of claim 16, wherein the machine learning model is for semantic segmentation of the plurality of image patches.

19. The computer-implemented system of claim 16, wherein applying the machine learning model to the plurality of image patches comprises:
generating, based on the plurality of feature classes, a plurality of label mask images corresponding to the plurality of image patches; and
identifying the one or more vugs or fractures in the plurality of core sample images using the generated plurality of label mask images.

20. The computer-implemented system of claim 16, wherein the machine learning model comprises a convolutional layer, a pooling layer, an upsampling layer, and a dropout layer.
